(19) United States
(12) Patent Application Publication
(10) Pub. No.: US 2018/0142141 A1
(43) Pub. Date: May 24, 2018

(54) HANDLE FOR SHAVING DEVICE COMPRISING A THERMOCHROMIC MATERIAL

(71) Applicant: The Gillette Company LLC, Boston, MA (US)

(72) Inventors: Pu Xiao, Beijing (CN); Dongpo Huang, Beijing (CN)

(21) Appl. No.: 15/797,350

(22) Filed: Oct. 30, 2017

(30) Foreign Application Priority Data
Nov. 24, 2016 (CN) 2016107012

(51) Int. Cl. C09K 9/02; B26B 21/22; B26B 21/40; G01K 11/16

(52) U.S. Cl. CPC C09K 9/02; G01K 11/16; B26B 21/4012; B26B 21/227

(57) ABSTRACT

A handle for a shaving razor including at least one thermochromic material which can provide color change when exposed to a pre-determined temperature.

### FIELD OF THE INVENTION

The present invention relates to a device, particularly a shaving razor, having a handle which changes color when exposed to a predetermined temperature.

### BACKGROUND OF THE INVENTION

There are many attempts in the razor field to enable easier cutting of body hair. Warm water is used to soften hair and/or reduce the skin irritation while shaving. Of course if the water temperature is too hot, the user's skin can be irritated or harmed. Users will often assess the appropriate temperature by tactile feel (e.g., placing a finger under running tap water). However, this lacks precision or accuracy to detect an ideal water (i.e., aqueous solution) temperature for shaving.

Thermochromic materials are known to change color when exposed to a predetermined temperature. A razor cartridge including a thermochromic material in a form of strip that is mounted on or molded into the razor cartridge housing to indicate the temperature change has been described (as a so called indicator strip). See e.g., U.S. Pat. No. 6,868,610. However, there is at least one of many potential disadvantages in having the thermochromic material located in the razor cartridge. For example, firstly, the use of such an indicator strip on the cartridge may require an extra molding or mounting step in manufacturing the device which may result in undue manufacturing complexity and costs. Secondly, it is desirable for plastics used for making cartridge housing to have certain rigidity or flexibility to hold the blades tightly. However, based on inventor's unpublished observations, some thermochromic materials may negatively affect the property (e.g., rigidity or brittleness) of the plastics when embedded therein. This may increase design requirements or limit the range of available plastics. Thirdly, a user may not be able to clearly observe the color change of the small indicator strip due to the relatively small surface area of the razor cartridge, especially when using soap or shaving cream, which may produce foam to obscure the indicator from view. Thus, there is a need to provide thermochromic materials away from the razor cartridge but still provide improved precision or accuracy in detecting the ideal aqueous solution temperature for shaving.

Razors comprising temperature-sensitive capsules have been reported. The color of the temperature-sensitive capsule changes when the water temperature becomes higher than a specific temperature level. Temperature-sensitive capsules may include leuco dye, coloring agent, and wax. The temperature-sensitive capsule reacts and changes color at 25° C. or higher. It is also reported that these capsules may be embedded in all parts of the razor except in a blade. This includes embedding the capsules in a cartridge body or a handle as well in the lubricating band or the guard. See e.g., US 2012/0279070.

However, there is at least one of many potential disadvantages in having the temperature-sensitive capsules located in potentially all parts of the razor, especially capsules containing waxes. Firstly, there is a continuing need to reduce costs and increase manufacturing feasibility and flexibility. Secondly, there is a need to magnify the visual impact of a change in color from the thermochromic material so the user can easily assess, with accuracy or precision, the ideal temperature for shaving.

### SUMMARY OF THE INVENTION

The present invention attempts to address at least one of these needs by providing a handle that comprises two parts interconnected with each other, which have different colors, and are made of different materials having different Shore hardness values, while one of the parts comprises a thermochromic material that provides a color change at a predetermined temperature, e.g. above 30° C. Specifically, the present invention is based on the surprising observation that thermochromic systems are easily miscible in variety of plastics, of specific mention of those plastics that generally have a lower hardness value that are typical of softer or more grip-able handles. This is particularly useful in those razors having handles comprise two or more different plastics types (having different hardness values). Still further, the present invention is based on the surprising discovery that users may prefer to have contrasting colors in the handle to further emphasize when a change at a predetermined temperature is achieved.

One advantage of the present invention is that handle portion containing the thermochromic material is more visible to the user and avoids the potential complications of incorporating this material in non-handle components of a razor (e.g., razor cartridge).

Another advantage is the handle portion containing the thermochromic material changes in color at the predetermined temperature at 30° C. or above (as compared to temperatures below this value). Applicant's unpublished observations would suggest that shaving with an aqueous solution at or above this temperature provides an improved shaving experience as compared to temperature below 30° C. Another advantage of the present invention is that the handle comprises two parts which are made by different materials having different hardness. Accordingly, a two-shot molding process is applied for making the handle of the present invention, in which the part made of a material having lower hardness forms a gripping part for easy handling and better friction.

Another advantage of the present invention is that the handle containing the thermochromic material turns to a red color when the predetermined temperature is at or above 40° C. The red color intuitively indicates to the user the aqueous solution temperature is too hot, such that the user's skin can be irritated or harmed.

Another advantage is that the handle containing the thermochromic material remains a purple color below the predetermined temperatures below 30° C. The purple color intuitively indicates to the user that aqueous solution temperature is too cold such that the user may achieve less ideal shaving experience.

Preferably, the thermochromic system comprises organic reversible thermochromic system. A typical organic reversible thermochromic system is comprised of a leuco dye, a developer and an organic hydrophobic solvent. Preferably, the organic hydrophobic solvent is non-wax solvent. Without wishing to be bound by theory, those color changing systems based upon waxes may have more narrow manufacturing tolerances (e.g., potentially either choice of plastic types and/or processing conditions, e.g., temperature range accuracy) as compared to the solvent based systems of the present invention.

One aspect of the present invention provides a plastic handle for a personal care device, comprising a first part and a second part interconnected with each other, wherein the first part and the second part have different colors from each other; wherein the first part has a higher Shore hardness value than the second part; wherein the second part comprises at least one thermochromic material that changes color when exposed at a temperature of 30° C. or above. Preferably, the second part comprises at least a first thermochromic material and a second thermochromic material. Preferably, the thermochromic material(s) is present in an amount of from 0.01% to 10%, preferably from 0.1% to 5%, more preferably from 0.2% to 4%, even more preferably from 1% to 4%, by weight of the second part. Preferably, the thermochromic material is an organic reversible thermochromic system, and wherein the organic reversible thermochromic system is comprised of a leuco dye, a developer and an organic hydrophobic solvent.

Another aspect of the present invention provides a device, comprising: (a) the handle described in the present invention, and (b) a skin-contactable head attached, preferably detachably attached to the handle, wherein preferably the device is selected from the group consisting of a shaving razor, an electric shaver, and a skin-treating device.

Another aspect of the present invention provides a process for making a handle for a device described in the present invention, comprising the steps of: (a) first injection molding a first material into a first mold cavity to form a first part of the handle; (b) second injection molding a second material into a second mold cavity to form a second part of the handle, wherein the second part interconnects with the first part of the handle; and (c) optionally, third injection molding a third material into a third mold cavity to form a third part the handle, wherein the third part at least partially overlays either the first part or the second part, to form the handle.

These and other aspects of the present invention will become more apparent upon reading the following detailed description of the invention.

### BRIEF DESCRIPTION OF THE DRAWINGS

The embodiments set forth in the drawings are illustrative in nature and not intended to limit the invention defined by the claims. The following detailed description of the illustrative embodiments can be understood when read in conjunction with the following drawings, and in which:

FIG. 1 is a perspective view of a shaving razor according to the present invention.

FIG. 2 is a perspective view showing an example for a handle of the present invention.

FIG. 3 is a perspective view showing another example for a handle of the present invention.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

As used herein, the articles including “the”, “a” and “an” when used in a claim or in the specification, are understood to mean one or more of what is claimed or described.

As used herein, the terms “comprise”, “comprising”, “include”, “including”, are meant to be non-limiting, i.e., other steps and other ingredients which do not affect the end of result can be added.

As used herein, the term “substantially free of” or “substantially free from” refers to the presence of no more than 0.5%, preferably no more than 0.2%, and more preferably no more than 0.1%, of an indicated material in a composition, by total weight of such composition.

As used herein, the term “free of' means that the indicated material is not deliberately added to the composition, or preferably not present at analytically detectable levels. It is meant to include compositions whereby the indicated material is present only as an impurity of one of the other materials deliberately added.

In this description, all concentrations and ratios are on a weight basis unless otherwise specified.

The device in the present invention may be a shaving razor, an electric shaver, or a skin-treating device. The present device may comprise a skin-contactable head, and a handle attached to the head. The skin-contactable head may be a replaceable one, i.e., the handle and skin-contactable head may be detachably attached. The handle can be connected to the head mechanically via e.g. an interlock member of any suitable type which may be either “male” or “female”.

The handle of the device of the present invention comprises a first part and a second part interconnected with each other, as described in more detail below and as shown in the accompanying figures. For example, the first part and the second part of the handle can be joined together or interlocked by chemically and/or mechanically bonding. In some embodiments, the first part and the second part may be formed by a two shot thermoplastic molding process, for example the first part is first injection molded and the second part is second injection molded, preferably the second part at least partially overlays the first part. Alternatively, the first and second parts of the handle may be mechanical fastened to each other, such as by snap lock fitting. Either the first part or the second part of the handle may include features such as recesses, projections, channels or openings to enhance bonding by increasing the bonding surface area or by creating mechanical interlocks.

The second part of the handle comprises at least one thermochromic material that is capable of providing a color change at a certain temperature. Preferably, the at least one thermochromic material is capable of providing a color change at a temperature of 30° C. or above, e.g., at 31° C., 32° C., 33° C., 34° C., 35° C., 36° C., 37° C., 38° C., 39° C., 40° C., or more. Preferably, the first part and the second part of the handle have different colors from each other, especially at ambient temperature, preferably as well as after color change. For example, the first part of the handle may be of a white color, and the second part of the handle may be of a purple color at ambient temperature (i.e., 25° C.). When the shaving razor is placed in aqueous solution, the second part of the handle will change color from e.g. purple to e.g. blue. Herein the term “aqueous solution” includes water and mixtures of water and other materials used in the shaving process. For example, the aqueous solution could be tap water; or wash basin containing a solution of water and optionally a surfactant or lubricant; or another mixture of water and other materials used to assist in a shaving operation. One of the advantages for the two parts of the handle having different colors is that the color contrast can give the consumer a clear visual signal for the color change of part of the handle, versus a configuration where the whole handle changes from one color to another, which may be difficult for the consumer to notice.

Preferably, the second part of the handle is composed of at least 40%, preferably at least 50%, more preferably at least 60%, still more preferably at least 70%, still more preferably at least 80%, and still more preferably at least 90%, of the surface area of the handle. The advantage is to ensure that at least a portion of surface area of the second part is exposed to the visual view when the handle is hold by a user's hand.

Preferably, the second part of the handle comprises two or more different thermochromic materials that are capable of changing color at different temperatures. Preferably, the second part of the handle comprises a first thermochromic material and a second thermochromic material, while the first thermochromic material provides a first color change at a first temperature, and the second thermochromic material provides a second color change at a second temperature. For example, the second part of the handle may be of orange color at ambient temperature and turns yellow when the handle is exposed to a desired temperature range (e.g. from 30° C. to 39° C.), and then turns white (or color fading) when the handle is exposed above a predetermined temperature (e.g., 40° C. and above, such as at 41° C., 42° C., 43° C., 44° C., 45° C. or above).

The first part of the handle may be made of any suitable material or combinations thereof. For example, the first part may include plastic selected from the group consisting of a polypropylene (PP) polymer, an acrylonitrile butadiene styrene (ABS), a polyethylene terephthalate (PET), a polycarbonate (PC), a polyoxymethylene (POM), a polystyrene (PS), a polyphenylene oxide (PPO), a polybutylene terephthalate (PBT), a polyamide (PA), a polymethyl methacrylate (PMMA), and combinations thereof. Preferably, the first part of the handle is made of a plastic having a Shore A hardness of 70 or above (e.g., 75, 80, 85, 90, or more) as measured according to ASTM D2240 00, preferably the Shore A hardness is from 70 to 90.

Preferably, the first part and the second part of the handle of the present invention have a different Shore hardness value from each other. Preferably, the first part of the handle has a higher Shore hardness value than the second part. Preferably, the second part of the handle is made primarily of a material having a Shore A Hardness of 65 or less, (e.g., 60, 55, 50, 45, 40, 30, 20, or less) as measured according to ASTM D2240 00, preferably the Shore A hardness is from 65 to 20. The second part of the handle can be made primarily of a material selected from the group consisting of a thermoplastic elastomer (TPE), a rubber, a silicone, and combinations thereof. If used, the rubber is preferably selected from the group consisting of a natural rubber, a butyl rubber, a nitrile rubber, a styrene butadiene rubber, and combination thereof. Preferably the TPE is selected from the group consisting of a styrene butadiene styrene (SBS) TPE, a styrene ethylene butadiene styrene (SEBS) TPE (e.g., Kraton), a polyester TPE (e.g., Hytrel), a polyamide TPE (Pebax), a polyurethane TPE, a polyolefin based TPE, and combinations thereof (e.g., polyester/SEBS blend). Preferably, the material is selected from the group consisting of a SBS TPE, a SEBS TPE, and combinations thereof. More preferably, the material is selected from the group consisting of a SBS TPE, a SEBS TPE, and combinations thereof. Preferably, the second part of the handle comprises from 90% to 99.99%, preferably from 95% to 99.9%, more preferably from 96% to 99.8%, by weight of the second part, of the TPEs or rubbers described above.

Preferably, the second part of the handle comprises from 0.01% to 10%, preferably from 0.1% to 5%, more preferably from 0.2% to 4%, by weight of the second part, of the thermochromic material(s). The thermochromic material incorporated in the second part of the handle is desired not to negatively impact the properties (such as tensile strength) of the handle made primarily of TPE materials.

The thermochromic material(s) comprised in the second part of the handle can be distributed over all or a portion of the second part. The thermochromic materials, if two or more present, may be distributed in one or more locale of the second part of the handle. In one embodiment, the second part of the handle comprises two thermochromic materials which are mixed and distributed over the entirety of the second part so that the second part changes color one time at a desired temperature (e.g. 30° C.) and changes color the second time at an undesired high temperature (e.g., 40° C.). Alternatively, the second part of the handle comprises a first thermochromic material and a second thermochromic material, where the first thermochromic material is distributed at a first locale of the second part, and the second thermochromic material is distributed at a second locale of the second part, and preferably wherein said first locale and second locale of the second part of the handle are discrete from each other. In this case, a first color change (e.g. from purple to blue) occurs in the first locale of the second part at a first temperature, e.g. at a desired temperature, and a second color change (e.g. from orange to red) occurs in the second locale of the second part at a second temperature, e.g. at an undesired high temperature.

Regarding the thermochromic material, different thermochromic mechanisms may be applicable depending upon the molecular structure. It may occur as a result of equilibrium between molecular species like acid-base, keto-enol, lactim-lactam, stereoisomers or between different crystal structures. Preferably the thermochromic material comprises an organic reversible thermochromic system. In turn, the organic reversible thermochromic system is preferably comprised of a leuco dye, a developer and an organic hydrophobic solvent. For example, the thermochromic material described in the present invention can be commercially available from Polyone (IL, USA) under tradename SmartBatch. Other thermochromic materials can also be used in the handle as desired.

The leuco dye may be selected from the group consisting of N-acyl leuco-methylene blue and derivative compounds thereof, fluoran dye compounds, diarylphthalide compounds, diphenylmethane compounds, spiropyran compounds, and combinations thereof; preferably the leuco dye is either a Crystal violet lactone analogues (diarylphthalide compounds) and fluoran dyes; wherein the developer is a weak acid, preferably the developer is selected from the group consisting of bisphenols, alkoxy-p-hydroxybenzoates, 1,2,3-triazoles, 4-hydroxycoumarin, and mixture thereof; and wherein the organic hydrophobic solvent is selected from the group consisting of alcohols, hydrocarbons, esters, ethers, ketones, fatty acids, amides, thiols, sulphides, disulphides and alcohol-acrylonitrile mixtures, and mixtures thereof. Preferably, the organic hydrophobic solvent is a non-wax solvent.

Preferably, the color of the second part of the handle changes within 30 seconds, preferably within 0.01 second to 10 seconds, more preferably within 0.1 second to 5 seconds, upon exposure of an aqueous solution at a temperature of 30° C. or above (i.e., the predetermined temperature that the subject thermochromic material turns color). For example, the handle can show a color change at the second part within 2 seconds, or within 1 second, or within 0.5 seconds upon exposure of a temperature of 30° C. or above.

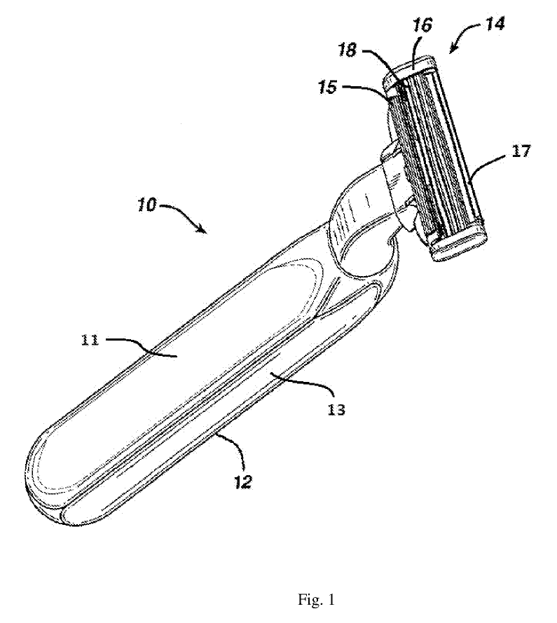

FIG. 1 is a perspective view of a shaving razor according to the present invention. Referring to FIG. 1, an example of a shaving razor 10 including a handle 12 and a razor cartridge 14 is shown. The razor cartridge 14 may include a molded plastic housing 16, which carries one or more blades 18 for shaving or trimming hair on the surface of skin. The cartridge 14 may be fixed or pivotably movable relative to the handle 12. Preferably, the razor cartridge 14 may be detachably attached to the handle 12 to enable the cartridge 14 to be replaced when the blade sharpness has diminished to an unsatisfactory level. The handle 12 may be designed to provide the cartridge 14 with good access to all shaving areas, particularly tight shaving areas (i.e. under the nose and around areas of the chin), by generally directing the handle 12 away from the cartridge 14. The razor cartridge 14 may also include other members such as guard 15 and shaving aids 17 (e.g. lubricating strip etc.). The handle 12 comprises a first part 11 and a second part 13, according to the present invention. The first part 11 and the second part 13 have different hardness and different color.

FIG. 2 is a perspective view of a handle according to the present invention. FIG. 2 shows an example of the handle 20 of the present invention including a first part 22 and the second part 24 is shown. The first part 22 is made of a material having a higher Shore hardness than the second part 24. For example, the first part 22 is made of a material having a Shore A hardness of 80 and the second part 24 is made of a polymer having a Shore A Hardness of 30. In some cases, the first part 22 may be made of the same material as the housing of the razor cartridge. Preferably, the second part 22 of the handle 20 includes a plurality of ribs or recesses to improve the user's grip of the handle 20, especially in wet environment. Preferably, the second part 22 comprises at least one thermochromic material that changes color at a temperature of 30° C. or above. For example, the second part 22 comprises at least two thermochromic materials, wherein one thermochromic material provides a first color change at a first temperature (e.g. 33° C.) and the second thermochromic material provides a second color change at a second temperature (e.g. 42° C.). Preferably, the first part 22 and the second part 24 have different colors at ambient temperature. Preferably, the first part 22 has a different color from the second part 24 both before and after the color change.

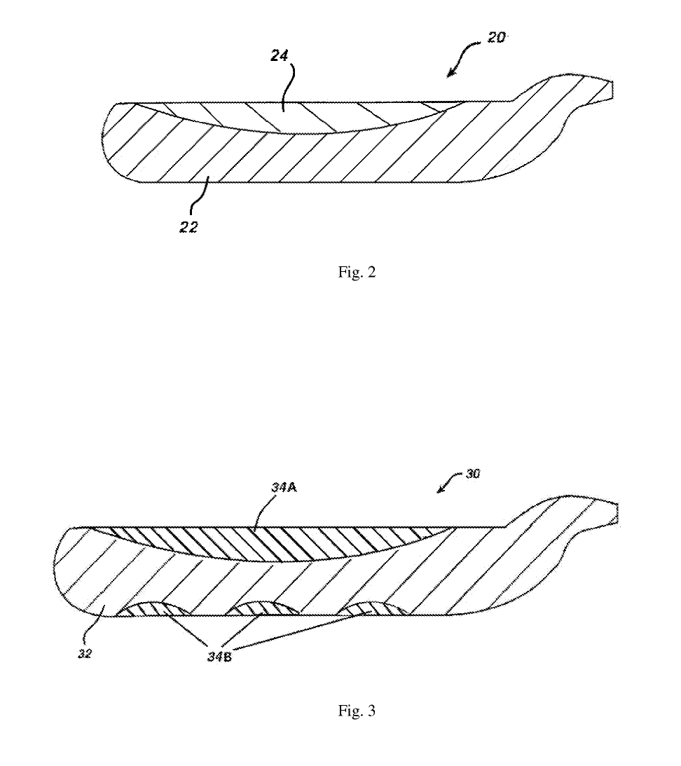

FIG. 3 shows another example of a handle for a shaving razor according to the present invention. Referring to FIG. 3, a handle 30 having a first part 32 and a second part 34 is shown. The second part 34 includes a first portion 34A and a second portion 34B, wherein the first portion 34A comprises a first thermochromic material which provides a color change at a first temperature, and the second portion 34B comprises a second thermochromic material which provides another color change at a second temperature. The first portion 34A may comprise a first and a second thermochromic material and the second portion 34B may comprise a third thermochromic material, and wherein the first and second thermochromic material in the first portion 34A are not the same as the third thermochromic material in the second portion 34B.

Method of Manufacture

The shaving razor 10 may be manufactured utilizing and suitable process, including but not limited to a continuous or semi-continuous molding process. A continuous molding process molds all of the components in-line to produce a finished product. A semi-continuous process may involve molding certain components in bulk and storing the components for later processing, such as additional molding steps.

The present invention provides a process for making a handle comprising a step of injection molding a first material into a first mold cavity to form a first part of the handle; and a step of injection molding a second material into a second mold cavity to form a second part of the handle interconnecting with the first part of the handle. Preferably, the first material and the second material are comprised of different polymer materials. More preferably, the first material and the second material have different Shore hardness values. The first material can be any material described hereinabove for the first part of the handle. The second material may comprise a primary thermoplastic elastomer material and comprises at least one thermochromic material which provides color change at predetermined temperature, as described hereinabove for the second part of the handle. Preferably, the thermochromic material is present at a level of from 0.01% to 10%, preferably from 0.1% to 5%, more preferably from 0.2% to 4%, by weight of the second material.

The thermochromic material may be provided by masterbatch commercially available e.g. from PolyOne, (SmartBatch™, IL, USA). Generally, masterbatch is a concentrated mixture of pigments and/or additives (herein the thermochromic material) encapsulated during a heat process into a carrier resin (preferably the primary thermoplastic elastomer material herein) which is then cooled and cut into a granular shape. The masterbatch usually contains 40% to 65% of the raw additive (thermochromic material). One of the advantages for using masterbatches versus using pure thermochromic material/pigment is that the former can alleviate the issues with the additive or colorant clumping or insufficient dispersion, as well as have longer shelf life. The relatively dilute nature of masterbatches (in comparison with the raw additives) also allows higher accuracy in dosing small amounts of expensive components.

Alternatively, the second material for the second part of the handle in the present invention is provided by a fully compounded material of the primary thermoplastic elastomer plus the thermochromic material. An advantage of using a fully compounded material is to achieve better dispersion and more accurate color. But it may be more expensive (cost saving on storage and transportation) and less open to product differentiation e.g., providing color variability of the product.

Optionally, the process comprises a step of injection molding a third material into a third mold cavity to form a third part the handle, wherein the third part at least partially overlays either the first part or the second part, to form the handle. Preferably, the third material may comprise at least one thermochromic material which is not the same as the thermochromic material used in the second material. In such case, the handle can show a first color change at a first temperature at the locale where the second material is distributed and can show a second color change at a second temperature at the locale where the third material is distributed.

The process of making the handle of the present invention can be conducted by using an injection molding machine (e.g. commercially available from Kawaguchi, Japan, or Engel, Schwertberg, Austria). The injection molding steps are conducted at a temperature of no higher than 230° C., preferably from 100° C. to 220° C., more preferably from 140° C. to 210° C.

### EXAMPLE 1

A process for making an example of a handle of the present invention is as follows:
1. Using an injection molding machine type Kawaguchi KX280.
2. Providing a handle mold with a first mold cavity and a second mold cavity which interconnected with each other.
3. First injection molding a PP material (Flint Hills Resources, USA) into the first mold cavity to form a first part of the handle. The processing temperature for this step is between 180° C. to 210° C. The first part of the handle is of white color.
4. Second injection molding a TPE compound (DYNALLOY, PolyOne) of 98 parts together with a thermochromic masterbatch from PolyOne (SmartBatch™) of 2 parts into the second mold cavity to form the second part of the handle which is interconnected with the first part of the handle. The processing temperature for this step is between 180° C. to 210° C. The second part of the handle at ambient temperature (i.e., 25° C.) is of purple color.

The handle made in Example 1 above is put in a beaker filled with tap water at ambient temperature, and then move it to another beaker filled with tap water of temperature above 35° C. It shows clearly that part of the handle changes its color from purple to blue within 1 second when it is transferred from tap water at ambient temperature to a tap water at a temperature above 35° C. Combinations:

An example is below:
A. A handle for a personal care device, comprising a first part and a second part interconnected with each other,
   wherein the first part and the second part have different colors from each other at an ambient temperature;
   wherein the first part has a higher Shore hardness value than the second part; and
   wherein the second part comprises at least one thermochromic material that changes color when exposed to a temperature of 30° C. or above.
B. The handle according to Paragraph A, wherein the second part comprises a first thermochromic material and a second thermochromic material, wherein the first thermochromic material provides a first color change at a first temperature, and the second thermochromic material provides a second color change at a second temperature.
C. The handle according to pParagraph B, wherein the first temperature is from 30° C. to 39° C., and the second temperature is from above 40° C. to 45° C.
D. The handle according to any of Paragraphs A-C, wherein the first thermochromic material is distributed throughout a first portion of the second part, and the second thermochromic material is distributed throughout a second portion of the second part, and preferably wherein said first portion and second portion of the second part of the handle are discrete from each other.
E. The handle according to any of Paragraphs A-D, wherein the thermochromic material(s) is present in an amount of from 0.01% to 10%, preferably from 0.1% to 5%, more preferably from 0.2% to 4%, even more preferably from 1% to 4%, by weight of the second part.
F. The handle according to any of Paragraphs A-E, wherein the color changes within 180 seconds, preferably from 0.01 seconds to 10 seconds, more preferably within 5 seconds, upon exposure to a temperature of 30° C. or above.
G. The handle according to any of Paragraphs A-F, wherein the thermochromic material comprises an organic reversible thermochromic system; and preferably the first part is free or substantially free of the organic reversible thermochromic system.
H. The handle according to any of Paragraphs A-G, wherein the thermochromic material is an organic reversible thermochromic system, and wherein the organic reversible thermochromic system is comprised of a leuco dye, a developer and an organic hydrophobic solvent,
   a. wherein the leuco dye is selected from the group consisting of N-acyl leuco-methylene blue and derivative compounds thereof, fluoran dye compounds, diarylphthalide compounds, diphenylmethane compounds, spiropyran compounds, and combinations thereof;
   b. wherein the developer is a weak acid, selected from the group consisting of bisphenols, alkoxy-p-hydroxybenzoates, 1,2,3-triazoles, 4-hydroxycoumarin, and combinations thereof; and
   c. wherein the organic hydrophobic solvent is selected from the group consisting of alcohols, esters, ethers, ketones, fatty acids, amides, thiols, sulphides, disulphides and alcohol-acrylonitrile mixtures, and combinations thereof, preferably the organic hydrophobic solvent is a non-wax solvent.
I. The handle according to any of Paragraphs A-H, wherein the first part comprises a material selected from the group consisting of a polypropylene (PP) polymer, an acrylonitrile butadiene styrene (ABS), a polyethylene terephthalate (PET), a polycarbonate (PC), a polyoxymethylene (POM), a polystyrene (PS), a polyphenylene oxide (PPO), a polybutylene terephthalate (PBT), a polyamide (PA), a polymethyl methacrylate (PMMA) and combinations thereof.
J. The handle according to any of Paragraphs A-I, wherein the second part further comprises a material selected from the group consisting of a thermoplastic elastomer (TPE), a rubber, a silicone, and combinations thereof; wherein preferably the rubber is selected from the group consisting of a natural rubber, a butyl rubber, a nitrile rubber, a styrene butadiene rubber, and combination thereof; wherein preferably the TPE is selected from the group consisting of a styrene butadiene styrene (SBS) TPE, a styrene ethylene butadiene styrene (SEBS) TPE, a polyester TPE, a polyamide TPE, a polyurethane TPE, a polyolefin based TPE, and combinations thereof; preferably the material is selected from the group consisting of SBS TPE, SEBS TPE, and combinations thereof.
K. A plastic handle for a shaving razor, comprising a first part and a second part interconnected with each other,
   wherein the first part comprises a PP polymer and has a Shore A hardness of 70 to 90;
   wherein the second part comprises a TPE material and has a Shore A hardness of 40 to 60,
   wherein the second part further comprises a first thermochromic material and a second thermochromic material, wherein the first thermochromic material provides a first color change at a temperature of 30° C. to 39° C., and the second thermochromic material provides a second color change at a temperature from above 40° C. to 45° C.;
   wherein the thermochromic materials are organic reversible thermochromic materials;
   wherein the first part is free or substantially free of the organic reversible thermochromic system.
L. A device, comprising:
   a) the handle according to any of Paragraphs A-K, and
   b) a skin-contactable head attached, preferably detachably attached to the handle,
   wherein preferably the device is selected from the group consisting of a shaving razor, an electric shaver, and a skin-treating device.
M. A process for making a handle according to any of Paragraphs A-J, comprising the steps of:
   a) injection molding a first material into a first mold cavity to form a first part of the handle;
   b) injection molding a second material into a second mold cavity to form a second part of the handle, wherein the second part interconnects with the first part of the handle; and
   c) optionally, injection molding a third material into a third mold cavity to form a third part the handle, wherein the third part at least partially overlays either the first part or the second part, to form the handle.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A handle for a personal care device, comprising a first part and a second part interconnected with each other,
wherein the first part and the second part have different colors from each other at an ambient temperature;
wherein the first part has a higher Shore hardness value than the second part; and
wherein the second part comprises at least one thermochromic material that changes color when exposed to a temperature of 30° C. or above.

2. The handle according to claim 1, wherein the second part comprises a first thermochromic material and a second thermochromic material, wherein the first thermochromic material provides a first color change at a first temperature, and the second thermochromic material provides a second color change at a second temperature.

3. The handle according to claim 2, wherein the first temperature is from 30° C. to 39° C., and the second temperature is from 40° C. to 45° C.

4. The handle according to claim 2, wherein the first thermochromic material is distributed throughout a first portion of the second part, and the second thermochromic material is distributed throughout a second portion of the second part, and preferably wherein said first portion and second portion of the second part of the handle are discrete from each other.

5. The handle according to claim 1, wherein the thermochromic material(s) is present in an amount of from 0.01% to 10% by weight of the second part.

6. The handle according to claim 1, wherein the color changes within 180 seconds upon exposure to a temperature of 30° C. or above.

7. The handle according to claim 1, wherein the thermochromic material comprises an organic reversible thermochromic system.

8. The handle according to claim 1, wherein the thermochromic material is an organic reversible thermochromic system, and wherein the organic reversible thermochromic system is comprised of a leuco dye, a developer and an organic hydrophobic solvent,
a) wherein the leuco dye is selected from the group consisting of N-acyl leuco-methylene blue and derivative compounds thereof, fluoran dye compounds, diarylphthalide compounds, diphenylmethane compounds, spiropyran compounds, and combinations thereof;
b) wherein the developer is a weak acid, selected from the group consisting of bisphenols, alkoxy-p-hydroxybenzoates, 1,2,3-triazoles, 4-hydroxycoumarin, and combinations thereof; and
c) wherein the organic hydrophobic solvent is selected from the group consisting of alcohols, esters, ethers, ketones, fatty acids, amides, thiols, sulphides, disulphides and alcohol-acrylonitrile mixtures, and combinations thereof, preferably the organic hydrophobic solvent is a non-wax solvent.

9. The handle according to claim 1 wherein the first part comprises a material selected from the group consisting of a polypropylene (PP) polymer, an acrylonitrile butadiene styrene (ABS), a polyethylene terephthalate (PET), a polycarbonate (PC), a polyoxymethylene (POM), a polystyrene (PS), a polyphenylene oxide (PPO), a polybutylene terephthalate (PBT), a polyamide (PA), a polymethyl methacrylate (PMMA) and combinations thereof.

10. The handle according to claim 1, wherein the second part further comprises a material selected from the group consisting of a thermoplastic elastomer (TPE), a rubber, a silicone, and combinations thereof; wherein preferably the rubber is selected from the group consisting of a natural rubber, a butyl rubber, a nitrile rubber, a styrene butadiene rubber, and combination thereof; wherein preferably the TPE is selected from the group consisting of a styrene butadiene styrene (SBS) TPE, a styrene ethylene butadiene styrene (SEBS) TPE, a polyester TPE, a polyamide TPE, a polyurethane TPE, a polyolefin based TPE, and combinations thereof; preferably the material is selected from the group consisting of SBS TPE, SEBS TPE, and combinations thereof.

11. A plastic handle for a shaving razor, comprising a first part and a second part interconnected with each other,
wherein the first part comprises a PP polymer and has a Shore A hardness of 70 to 90;
wherein the second part comprises a TPE material and has a Shore A hardness of 40 to 60,
wherein the second part further comprises a first thermochromic material and a second thermochromic material, wherein the first thermochromic material provides a first color change at a temperature of 30° C. to 39° C., and the second thermochromic material provides a second color change at a temperature from 40° C. to 45° C.;
wherein the thermochromic materials are organic reversible thermochromic materials;
wherein the first part is free or substantially free of the organic reversible thermochromic system.

12. A device, comprising:
c) the handle according to claim 11, and
d) a skin-contactable head attached, preferably detachably attached to the handle, wherein preferably the device is selected from the group consisting of a shaving razor, an electric shaver, and a skin-treating device.

13. A process for making a handle according to claim 1, comprising the steps of:
d) injection molding a first material into a first mold cavity to form a first part of the handle;
e) injection molding a second material into a second mold cavity to form a second part of the handle, wherein the second part interconnects with the first part of the handle; and
f) optionally, injection molding a third material into a third mold cavity to form a third part the handle, wherein the third part at least partially overlays either the first part or the second part, to form the handle.
